(19) United States
(12) Patent Application Publication
(10) Pub. No.: US 2022/0323180 A1
(43) Pub. Date: Oct. 13, 2022

(54) METHOD FOR MAKING HARD CLEAR ALIGNER SET FOR STEPWISE ORTHODONTIC TREATMENT

(71) Applicants: SKYNET ELECTRONIC CO., LTD., Taipei (TW); Hangzhou Health Tooth Medical Instruments Company Limited, Hangzou City (CN)

(72) Inventors: Ching-Hung LIANG, Taipei City (TW); Yi-Chen YANG, Tainan City (TW); Chien-Te HO, Tainan City (TW)

(73) Assignees: SKYNET ELECTRONIC CO., LTD., Taipei (TW); Hangzhou Health Tooth Medical Instruments Company Limited, Hangzhou City (CN)

(21) Appl. No.: 17/225,158

(22) Filed: Apr. 8, 2021

(51) Int. Cl. A61C 7/00; A61C 7/08

(52) U.S. Cl. CPC A61C 7/002; A61C 7/08

(57) ABSTRACT

A method for making a hard clear aligner set for stepwise orthodontic treatment is provided. The hard clear aligner set includes plural intermediate aligners made as follows. First, original tooth-row image files corresponding to a patient's teeth are obtained. Tooth arranging software is then used to produce final tooth-row image files by rearranging the teeth in the original tooth-row image files, define the displacements and rotation angles required for the patient's teeth in each step of the treatment, and after computation, produce plural stepwise tooth-row image files. Following that, dedicated software is used to define the surface thickness in each stepwise tooth-row image file, thereby producing shell-like aligner image files corresponding respectively to the intermediate aligners. The shell-like aligner image files are subsequently converted into digital control instructions in order to control a multiaxial carving machine to carve hard clear aligners from hard polymeric modular blocks.

### BACKGROUND OF THE INVENTION

### 1. Technical Field

The present invention relates to a method for making a hard clear aligner set for stepwise orthodontic treatment, more particularly relating to a method for making a hard clear aligner set by carving modular blocks whose hardness is similar to that of the enamel of the dental crown.

### 2. Description of Related Art

The earliest method of orthodontic treatment entails bonding a plurality of brackets respectively and adhesively to a plurality of dental crowns, passing an arch wire through the brackets, and tightening the arch wire to generate stress in the dental crowns and thereby force the corresponding teeth to move slowly to their respective intended positions. Referring to FIG. 1, the exposed portion of the tooth 10 is called the dental crown 11, and the unexposed portion is called the tooth root 12. The surface of the dental crown 11 is formed by a layer of enamel 13, which is of very high hardness. The tooth 10 is supported by a bony tissue known as dentin 14, against which the gum 15 lies. Venules 16, arterioles 17, and dental nerves 18 pass through the tooth canals 19 into the pulp 120. The periodontium 122 is located between the dentin 14 and the alveolar bone 121 and is populated by a large number of ligaments 123. The ligaments 123 are an important tissue that fastens the tooth 10 to the tooth socket.

The principle on which the tooth 10 can be moved and thereby corrected in position is briefly stated as follows. When the tooth 10 is under stress, the ligaments 123 are also subjected to internal forces of the tooth 10. As a result, the alveolar bone 121 grows where the ligaments 123 are tightened, and is resorbed by osteoclasts where the ligaments 123 slacken. Once the pulling forces acting on the ligaments 123 are in equilibrium, the tooth 10, which has been moved under stress, is secured in the new tooth socket by the ligaments 123. During the process, the neighboring tissue slowly adapts to the displacement of the tooth 10 too. Orthodontic treatment with brackets and arch wires is an application of the foregoing principle and must be performed by an experienced orthodontist who is familiar with the tooth structure, or problems may arise as the treatment proceeds.

The installation of brackets and arch wires takes an orthodontist a lot of time and is generally carried out in the following manner. To begin with, the tooth surfaces on which brackets are to be installed must be roughened by etching with a weak acid and then cleaned in order for each bracket to be securely bonded to the intended tooth surface. Once the brackets are in place, the installation of arch wires begins. Arch wires are available in various thicknesses and curvatures and are therefore difficult to install and prone to cause pain to the patient. Besides, over the long correction process (whose duration is measured in years) following the installation of arch wires, the patient is required to make frequent return visits to the dental clinic in order for the orthodontist to adjust the brackets and arch wires as needed. Moreover, the brackets and arch wires not only render the patient's oral cavity visually unpleasant, but also create gaps in which food residues tend to be stuck each time while the patient eats. As it is difficult to remove those food residues, bacterial growth takes place easily. In addition, the arch wires are likely to puncture the patient's lips or tongue. Therefore, considering the aforesaid long-term inconveniences in daily life, those who need orthodontic treatment are often reluctant to use the bracket-and-arch-wire method unless there are no other options.

Recently, a new option for orthodontic treatment emerged in the form of clear aligners, and stepwise orthodontic treatment with clear aligners has become more and more popular since 1997, when Align Technology, Inc. who was founded in the United States and began to promote its clear aligners under the brand name of “Invisalign”. Well-known brands other than “Invisalign” of the US include “angelalign” and “Smartee” of China, “K Clear” of Germany, and “ASO Aligner” of Japan, all of which provide custom-made products. Those branded clear aligners are made in more or less the same way, i.e., by molding a sheet of soft clear plastic of uniform thickness with a three-dimensionally (3D) printed dental model in a heated environment where a vacuum is created by a suction pump. This method, generally known as the suck-down method, has been extensively used to process and shape plastic material in many fields.

Clear aligner-assisted orthodontic treatment is based on the stepwise tooth displacement theory proposed by H. D. Kesling in 1945. While Kesling validated his theory through experiments, the orthodontic device technology back then was such that making a pair of aligners was both labor-intensive and time-consuming, and that mass production was out of the question. However, the stepwise tooth displacement theory is so appealing that improvements have been persistently made on the manufacturing process of aligners, with a view to commercialization, but little success was achieved. Kesling's theory was not commercialized until the rapid development of computers and related technologies enabled Align Technology to turn the theory into products by way of computer software. After the patent term of Align Technology expired, other brands appeared one after another. Apart from developing soft clear plastic materials of different toughnesses and thicknesses to differentiate their respective products, all the aligner manufacturers use the suck-down method, whose steps may vary slightly from one manufacturer to another but generally include the following six steps:

Step 1: Digital image files of a patient's upper row of teeth 20 and lower row of teeth 21 (see FIG. 2A) and of a proper occlusion configuration 22 (see FIG. 2B) of the patient's upper and lower rows of teeth are obtained by an oral cavity scanning method as the patient's original tooth-row image files 30 (see FIG. 3A).

Step 2: The teeth in the original tooth-row image files 30 are rearranged into their respective ideal positions with tooth arranging software to produce final tooth-row image files 31 (see FIG. 3B).

Step 3: The displacements, rotation angles, and other parameters required for the patient's teeth in each stage of the treatment are calculated and defined by the tooth arranging software, based on the patient's age and jawbone health conditions. After computation by the tooth arranging software, a plurality of intermediate tooth-row image files that transition from the original tooth-row image files 30 to the final tooth-row image files 31 are obtained.

Step 4: Using a three-dimensional object printer (3D printer), a plurality of physical intermediate dental models 41 are printed out of a photocurable resin according to the intermediate tooth-row image files.

Step 5: A plastic sheet 40 that can be shaped by a heating and vacuum forming method is heated and pressed onto one of the physical dental models 41, which serves as a mold, (see FIG. 4A) while a vacuum is created by a powerful suction pump to shape the plastic sheet 40. Once cooled down, the plastic sheet 42 having an impression of the dental model 41 (see FIG. 4B) is removed from the dental model 41. A hot knife or a pair of sharp scissors are then used to trim the shaped sheet 42 along the gum line to produce a soft clear aligner 43 for the upper or lower row of teeth (see FIG. 4C).

Step 6: The remaining soft clear aligners 43 are sequentially formed in the same way as in step 5 based on the other intermediate tooth-row image files to complete the aligner set required for the intended orthodontic treatment.

The soft clear aligners 43, which are made of a plastic material that can be shaped by a heating and vacuum forming method, are softer than tooth enamel, have a smooth surface, and therefore fail to apply sufficient retaining force on the wearer's teeth. The friction between a soft clear aligner 43 and the corresponding teeth is also insufficient such that the corrective effect of the soft clear aligners 43 on the molar teeth, which are double-rooted, is less than satisfactory.

Due to the soft clear aligners 43 have insufficient retaining force, it is likely that they will fall off after being worn for only a few days. To solve this problem, Align Technology pioneered the use of an attaching device called attachment, claiming that the corrective effect of aligners can be enhanced by bonding those attaching devices adhesively to the teeth. However, adhering the attaching devices to a patient's teeth is no easy matter. First, the image files 50 of differently shaped attaching devices must be incorporated into the original tooth-row image files 30 (see FIG. 5A) before the tooth arranging step. When 3D printing of the physical dental models is completed, therefore, the models of the attaching devices are already an integral part of the dental models. It follows that each subsequently formed aligner has protuberances on the outer side and recesses on the inner side, wherein the protuberances and recesses are in the shapes of the attaching devices. To adhere the physical attaching devices to the teeth securely, an orthodontist has to etch the tooth surfaces slightly with a weak acid, clean the etched tooth surfaces, fill the aforesaid recesses of the step-0 aligners with a photocurable epoxy, have the patient put on the step-0 aligners in order to perform a photocuring process on the epoxy, and then remove the step-0 aligners, leaving the physical clinical attaching devices 51 on the teeth (see FIG. 5B). Only after that can the step-0 aligners be properly put on the patient's teeth to start stepwise orthodontic treatment.

Such soft aligners require to be worn for at least 22 hours per day and should not be taken off unless the wearer is about to chew food or brush their teeth. If the aligners are taken off so forcefully that a certain attaching device falls off, the wearer must go to the orthodontist again in order to adhere that attaching device back in place.

In addition, because the soft aligners are smooth and not hard enough, there is insufficient friction between such an aligner and the corresponding teeth. Moreover, since a soft aligner is shaped by heating a plastic material and then subjecting the heated plastic material to a vacuum created by a strong suction pump, the thickness of the aligner tends to be non-uniform, and each portion of the aligner that corresponds to the gap between two adjacent teeth is often curved such that the area of contact between the aligner and the teeth, and consequently the corrective stress generated, are reduced. Soft aligners, therefore, have little corrective effect on the molar teeth, which are double-rooted.

Soft clear aligners work well in the orthodontic treatment of the incisors but not so well in treating other single-rooted teeth such as the canine teeth and the premolar teeth. This is why during an orthodontic treatment, it is often required that a new aligner set be made, which involves scanning the patient's oral cavity again, rearranging the patient's teeth through software, and performing more 3D printing, and which therefore prolongs the treatment and may exhaust the patient's patience. As a compensation, some aligner manufacturers offer to make a second aligner set for free.

In addition, 3D printed physical dental models are made of photocurable epoxy and cannot be recycled for reuse; that is to say, they become a waste after single use. Not only that, the more the intermediate aligners, the more the waste, which is an inevitable environmental issue associated with the production of soft clear aligners.

Aside from making orthodontic aligners from a plastic material that can be shaped by a heating and vacuum forming method, Published US Patent Application No. 2008/0254402A1 uses a CNC (computerized numerical control)-based carving method to produce aligners out of a soft material but has the same drawbacks as making aligners by a heating and vacuum forming method. Published US Patent Application No. 2006/0093982A1 discloses producing a digital dental aligner model suitable for CNC-based manufacturing based on a digital dental arch model, segmenting the digital dental aligner model into a plurality of manufacturable digital components, producing aligner components using CNC-based manufacturing in accordance with the digital aligner components, and assembling the aligner components to form an orthodontic dental aligner. This method, however, is overly complicated, not to mention that the joints between the assembled aligner components have lost their intended stress and are therefore orthodontically ineffective.

In light of the above, it is an important issue in the orthodontic industry to solve the aforementioned drawbacks of clear aligners (soft aligners) effectively—for example, to dispense with the onerous attachment adhering operation (whose effect has yet to be verified), to increase the retaining force and friction of clear aligners (soft aligners), and to reduce waste aligner models-so that clear aligners (soft aligners) can produce exactly the intended orthodontic effect. The very issue is addressed by the present invention.

### BRIEF SUMMARY OF THE INVENTION

In view of, and in order to provide an effective solution to, the aforesaid drawbacks of the existing soft aligners, the inventor of the present invention conducted an extensive research and repeated tests and finally succeeded in developing a method for making a hard clear aligner set for stepwise orthodontic treatment.

One objective of the present invention is to provide a method for making a hard clear aligner set for stepwise orthodontic treatment. The method begins by constructing digital image files of a patient's upper row of teeth, lower row of teeth, and proper occlusion configuration of the upper and lower rows of teeth through a scanning process, with each digital image file obtained serving as an original tooth-row image file. Following that, each original tooth-row image file is read with tooth arranging software in order to produce a corresponding final tooth-row image file in which the teeth have been rearranged, and to calculate and define at least the displacements and rotation angles required for the patient's teeth in each stage of the stepwise orthodontic treatment. After computation by a tooth arranging software, a plurality of stepwise tooth-row image files transitioning from each original tooth-row image file to the corresponding final tooth-row image file are obtained. A dedicated software is then used to calculate and define the thicknesses of the tooth surfaces in each stepwise tooth-row image file and in each final tooth-row image file so as to produce the corresponding shell-like aligner image files. Lastly, each shell-like aligner image file is converted into a digital control instruction for controlling a multiaxial carving machine, in order for the multiaxial carving machine to produce a plurality of intermediate aligners by carving hard polymeric modular blocks, thereby forming a hard clear aligner set. The method of the invention allows the hard clear aligner set to be rapidly made. Moreover, the patient for whom the hard clear aligner set is made only has to wear the intermediate aligners successively at the preplanned intervals, and the intended orthodontic effect will be achieved.

### BRIEF DESCRIPTION OF THE SEVERAL VIEWS OF THE DRAWINGS

The objectives, technical features, and effects of the present invention can be better understood by referring to the following detailed description of an illustrative embodiment in conjunction with the accompanying drawings, in which:

FIG. 1 schematically shows the structure of a tooth;

FIG. 2A schematically shows a patient's original upper row of teeth and original lower row of teeth;

FIG. 2B schematically shows a proper occlusion configuration of the original upper and lower rows of teeth in FIG. 2A;

FIG. 3A schematically shows an original tooth-row image file;

FIG. 3B schematically shows a final tooth-row image file:

FIG. 4A schematically shows a plastic sheet that can be shaped by a vacuum forming method and a physical dental model;

FIG. 4B schematically shows the plastic sheet in FIG. 4A after it is shaped by the vacuum forming method;

FIG. 4C schematically shows a soft clear aligner,

FIG. 5A schematically shows an image file in which some of the teeth are respectively attached with attaching devices;

FIG. 5B schematically shows some teeth that are respectively attached with physical clinical attaching devices;

FIG. 6A schematically shows a hard modular block;

FIG. 6B schematically shows a hard modular block whose carving process is completed;

FIG. 6C schematically shows a pair of intermediate aligners;

FIG. 7 is a flowchart of the method of the invention;

FIG. 8A schematically shows a hard clear aligner with a carved-through portion;

FIG. 8B schematically shows a hard clear aligner provided with a physical substitute tooth portion: and

FIG. 8C schematically shows a relatively short aligner of the invention.

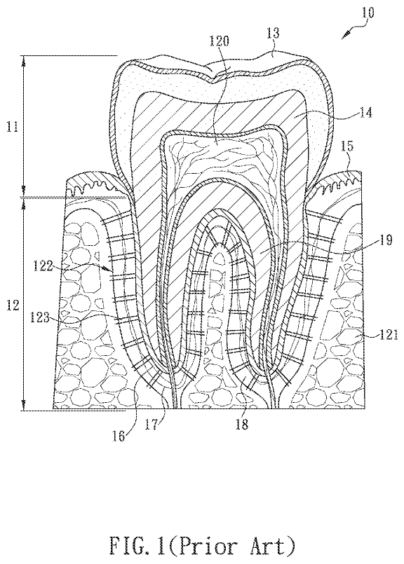

### DETAILED DESCRIPTION OF THE INVENTION

The method disclosed herein for making a hard clear aligner set for stepwise orthodontic treatment is detailed below with reference to an embodiment to enable a better understanding of the objectives, technical content, and advantages of the present invention. A person skilled in the an shall be able to understand the advantages and effects of the invention from the disclosure of this specification. The invention can be implemented or applied in many different ways, and the details provided herein may be modified or changed based on a different point of view or a different application without departing from the concept of the invention. It should also be pointed out that the accompanying drawings are only simplified schematic drawings and are not drawn to scale, and that although a detailed description of the technical content of the invention is given below, the disclosure is not intended to be restrictive of the scope of the patent protection sought by the applicant.

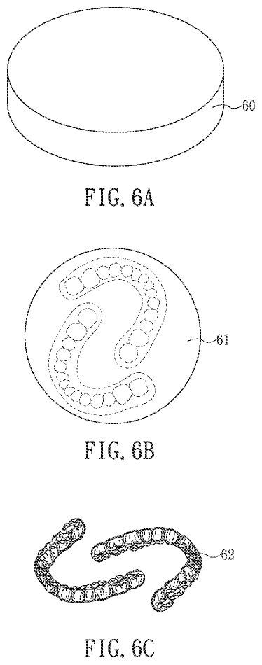

Based on years of practical experience in making CNC multiaxial carving machines for carving such dental appliances as dental prostheses and dental guards against bruxism- and also on the demand, and under the instruction, of orthodontists—the inventor of the present invention has chosen hard polymethyl methacrylate (hereinafter abbreviated as PMMA) modular blocks 60 (see FIG. 6A), which are generally used to carve dental prostheses, as the material from which to carve dental aligners. After numerous trials, improvements, and tests, hard clear aligners (i.e., the intermediate aligners 62 referred to in the following embodiment) that have great retaining force and sufficient friction were finally produced with success. The method of the invention does not require physical dental models to be made in advance by 3D printing.

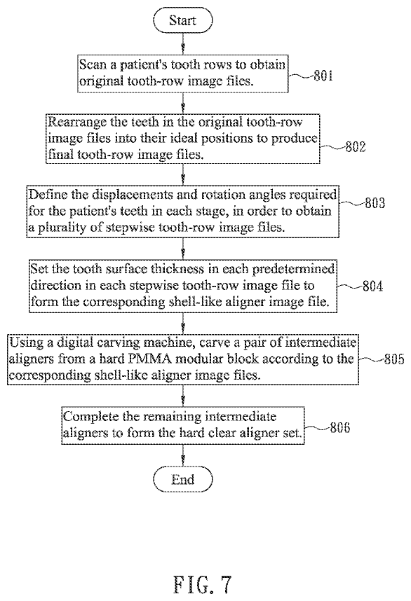

Generally, the production of hard as well as soft clear aligners requires that panoramic radiographs (commonly known as pano) be taken of a patient's entire oral cavity in order to determine the health conditions of the patient's teeth. Unhealthy teeth must be treated before orthodontic treatment, and teeth with an artificial root, such as a dental implant, should not be moved. Compared with the steps for making soft aligners, the steps of the present invention for making hard clear aligners dispense with the complicated procedure of adhering attaching devices, do not require 3D printing for making physical dental models, and do not use a heating and vacuum forming machine to shape the aligners or a multiaxial carving machine to trim the aligners. Referring to FIG. 7, the method of the invention is carried out as follows:

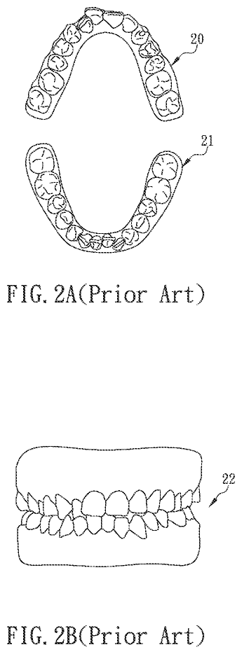

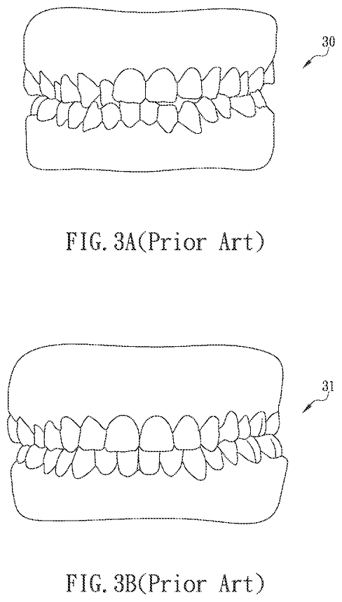

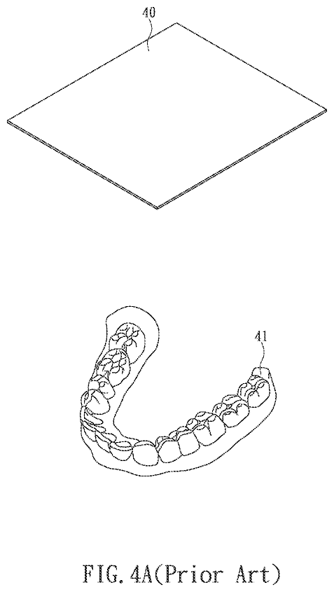

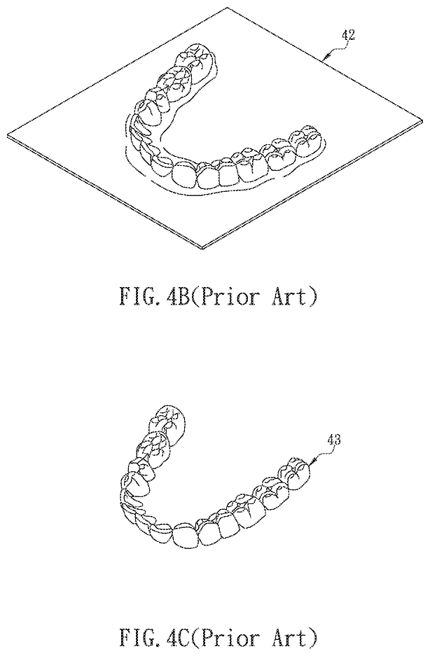

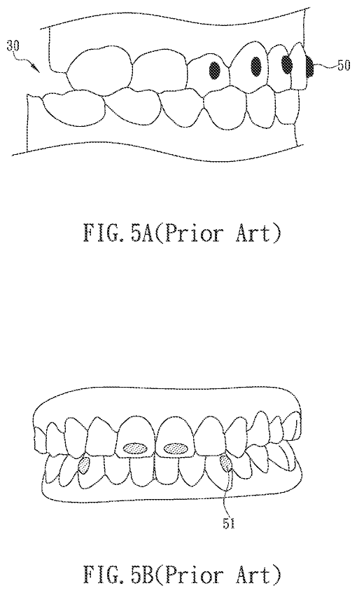

Step 801: A patient's tooth rows are scanned with a 3D scanning technique (e.g., with a 3D laser intraoral scanner) to obtain digital image files of the patient's upper row of teeth 20 and lower row of teeth 21 (see FIG. 2A) and of a proper occlusion configuration 22 of the patient's upper and lower rows of teeth (see FIG. 2B). The digital image files obtained serve as the patient's original tooth-row image files 30 (see FIG. 3A).

Step 802: Tooth arranging software is used to read each original tooth-row image file 30 and rearrange the teeth in each original tooth-row image file 30 into their respective ideal positions, thereby producing the corresponding final tooth-row image file 31 (see FIG. 3B).

Step 803: Based on the patient's age and jawbone conditions, the tooth arranging software is used to calculate and define the displacements, rotation angles, and other parameters required for the patient's teeth in each stage of the intended orthodontic treatment, and after computation by the tooth arranging software, a plurality of stepwise tooth-row image files transitioning from each original tooth-row image file 30 to the corresponding final tooth-row image file 31 are obtained.

Step 804: The tooth surface thickness in each stepwise tooth-row image file corresponding to the patient's upper/lower row of teeth and in each predetermined direction is set with dedicated software (e.g., computer-aided design, or CAD, software) to produce a shell-like aligner image file for each intermediate aligner.

Step 805: The shell-like aligner image file of each intermediate aligner is converted by computer-aided manufacturing, or CAM, software into a digital control instruction (e.g., a numerical control, or NCcode) that can be read by a digital carving machine. All the digital control instructions are sent to the controller of the digital carving machine. A hard PMMA modular block 60 (see FIG. 6A) is then secured on the table of the digital carving machine in order for the digital carving machine to carve the modular block into an aligner according to one of the digital control instructions, or a pair of aligners according to two of the digital control instructions, as shown in FIG. 6B. Once carving is completed, the carved modular block 61 (see FIG. 6B) is removed from the digital carving machine, and the aligners are cut from the modular block 61 and finished to complete a pair of intermediate aligners 62 (see FIG. 6C).

Step 806: The carving process of step 805 is repeated to make all the other intermediate aligners 62 and thereby complete a hard clear aligner set.

All the software required in the foregoing steps is commercially available. 3D laser intraoral scanners suitable for use in step 801 include Trios by 3Shape A/S, Omnicam by Dentsply Sirona, CS3600 by Carestream Dental LLC, and so on. Tooth arranging software suitable for use in step 802 and step 803 includes Ortho Analyzer by 3Shape, Ortho Analysis by INTEWARE Co., Ltd., Ortho by exocad GmbH, and so on. CAD software suitable for use in step 804 includes Orthedo System by 3Shape, Dental CAD by exocad, EZCAD by INTEWARE, iOtho by angelalign, and so on. CAM software suitable for use in step 805 includes MillBox by CIMsystem, Power Mill by Autodesk Inc., EZCAM by INTEWARE, and so on.

The multiaxial carving machine used in step 805 is a temporary dental prosthesis carving machine made by ARIX CNC Machines Co., Ltd. of Taiwan, with a machining precision of ±20 μm. The hard PMMA modular blocks 60 are made in the Wuxi (China) plant of YAMAHACHI DENTAL MFG., CO. of Japan; have a Shore hardness ranging from 75 to 85, which is similar to the hardness of the enamel of the dental crown; and are tough enough not to break into small pieces.

The method of the present invention has the following features and effects. First, PMMA, also known as organic glass, is a long-chain polymer that will not shatter when penetrated by a bullet and therefore can be used to make bulletproof glass. It not only has such advantageous features as high transparency, a low price, and high machinability, but also is a medical-grade material. PMMA is elastically rigid, and its hardness will not degrade, which makes it possible for a hard clear aligner (an intermediate aligner 62) carved from PMMA to maintain its retaining force, thereby preventing the problems and inconveniences associated with bonding the aforesaid attachments adhesively to a patient's teeth.

Second, making hard clear aligners by carving allows the inner side of each aligner to have a rough carved surface, which increases the friction between the hard clear aligner and the dental crowns in contact therewith. This feature plus sufficient hardness of the material enables the resulting hard clear aligners to move the molar teeth easily so that all the teeth can be corrected. Thus, not only can the front teeth, i.e., the incisors, be rendered into a visually pleasant arrangement, but also proper occlusion of the molar teeth, which are used for chewing, can be achieved, thereby allowing the molar teeth to grind food into sufficiently small pieces to help relieve the load on the digestive system, to facilitate digestion and nutrient absorption, and to enhance health as a result.

Moreover, when a hard clear aligner is made by carving, the thickness of each portion of the hard clear aligner (i.e., the distance between each outer surface portion of the aligner and the wearer's corresponding tooth portion can be calculated and defined by computer software (the aforesaid dedicated software), in order for the carving machine to carve the hard clear aligner accordingly. Thus, each portion of the hard clear aligner that corresponds to the gap between two adjacent teeth can be carved in the shape of a fin, and each fin will fit into the corresponding tooth gap when the hard clear aligner is worn to ensure the retaining force of the aligner and prevent the aligner from falling off. In addition, as each tooth will be enclosed more thoroughly by the hard clear aligner than achievable with the prior art, the force applied by the hard clear aligner to each dental crown will act on a larger area of the dental crown than achievable with the prior art, and the resulting stress will be uniformly distributed to enable each dental crown and the corresponding tooth root to move in a parallel manner, meaning each tooth will be moved as expected. If the force is applied unevenly to a dental crown, the biomechanics of teeth are such that the dental crown and the corresponding tooth root may move in opposite directions, and that the tooth root may move out of the alveolar bone in consequence, which is dangerous.

With the fins of each hard clear aligner (intermediate aligner 62) corresponding respectively to the wearer's tooth gaps to ensure the retaining force of the hard clear aligner, and with each hard clear aligner carved out of a PMMA modular block 60, the retaining force of each hard clear aligner will not degrade while the hard clear aligner is being worn. Also, the friction caused by the roughened inner surface of each hard clear aligner (intermediate aligner 62) allows each corresponding tooth, including the molar teeth, to be displaced by the hard clear aligner substantially in the intended manner. Therefore, the wearer only has to report remotely to the orthodontist about the wearing condition of the hard clear aligners in use, and if nothing abnormal has occurred, the wearer will be allowed to change the aligners by themselves according to the preset order and timetable, without having to go to the dental clinic during the orthodontic treatment. This is particularly convenient for patients who live in a remote rural area or who take long-distance business trips or travel frequently.

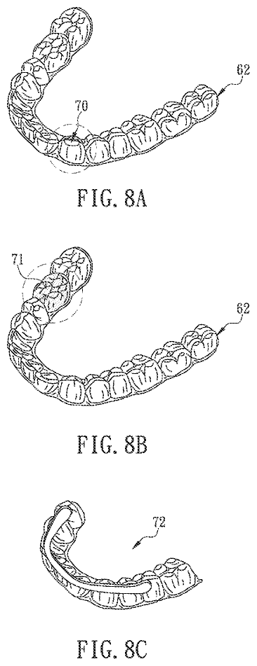

Furthermore, recent studies have shown that the best timing for orthodontic treatment is at the mixed dentition stage, i.e., at ages when the deciduous teeth are replaced by the permanent teeth. When a certain permanent tooth grows exceptionally fast, it is feasible to carve through (i.e., to form an opening 70 in, as indicated by the dashed-line circle in FIG. 8A) the portion of a hard clear aligner (intermediate aligner 62) that corresponds to the occlusal surface of that tooth, in order for the tooth to grow freely without hindrance. This carved-through configuration is difficult to achieve when making the conventional soft aligners, and it may be necessary to carve through the occlusal surface of an aligner on other occasions as well. Besides, if an adult wishes to have a tooth implanted in place of a missing tooth but has irregular tooth arrangement, it is preferable that orthodontic treatment precede the implantation, and that the hard clear aligners (intermediate aligners 62) made for the adult have a carved, physical substitute tooth portion 71 (see FIG. 8B) corresponding in position to the missing tooth so that the adjacent teeth will be supported and will not tilt toward the missing tooth. In this case, the aligners (intermediate aligners 62) may lose their orthodontic effect if not provided with the physical substitute tooth portion 71. The provision of the physical substitute tooth portion 71 is also difficult to achieve when making the conventional soft aligners.

If a patient needs orthodontic treatment for only a small number of teeth, and if the adjacent teeth are secure enough to serve as anchor teeth, a relatively short aligner 72 (see FIG. 8C) can be made by carving, thanks to the sufficient retaining force and friction of the hard clear aligners of the present invention. For example, if only the lower incisors need orthodontic treatment, and if the adjacent canine teeth and premolar teeth can serve as anchor teeth, it is feasible to make a relatively short aligner 72 as shown in FIG. 8C, with a carved-through portion corresponding to the top sides of the incisors and of the canine teeth. A relatively short aligner 72, therefore, does not correspond to the entire upper or lower row of teeth of a patient but only corresponds to some of the upper or lower row of teeth. A relatively short aligner 72 also feels more comfortable than the full-length version while being worn.

Last but not least, it is obvious that making dental aligners by carving does not require 3D printed physical dental models, which are good for single use only; therefore, waste physical dental models, which may otherwise exist in large quantities, will not be produced. The method of the present invention does not require a machine for performing a heating and vacuum forming method on plastic material, either. Moreover, the chips and scraps produced by carving PMMA raise no environmental issues because they have not gone through material changes related to chemical reaction and can therefore be recycled and reused.

While the invention herein disclosed has been described by means of specific embodiments, numerous modifications and variations could be made thereto by those skilled in the art without departing from the scope of the invention set forth in the claims.

What is claimed is:

1. A method for making a hard clear aligner set for stepwise orthodontic treatment, comprising the steps of:
obtaining digital image files of a patient's upper row of teeth, lower row of teeth, and proper occlusion configuration of the upper and the lower rows of teeth by a three-dimensional (3D) scanning technique, in order for each said digital image file obtained to serve as an original tooth-row image file;
reading each said original tooth-row image file, rearranging teeth in each said original tooth-row image file to produce a corresponding final tooth-row image file, calculating and defining at least displacements and rotation angles required for the patient's teeth in each stage of the stepwise orthodontic treatment, and performing computation to obtain a plurality of stepwise tooth-row image files transitioning from each said original tooth-row image file to the corresponding final tooth-row image file, by a tooth arranging software;
defining a tooth surface thickness in each said stepwise tooth-row image file and in each said final tooth-row image file, by a dedicated software, in order to obtain a plurality of shell-like aligner image files corresponding respectively to the stepwise tooth-row image files and the final tooth-row image files; and
converting each said shell-like aligner image file into a digital control instruction in order to control a multiaxial carving machine and make the multiaxial carving machine carve a plurality of intermediate aligners from hard polymeric modular blocks, thereby forming the hard clear aligner set.

2. The method of claim 1, wherein the hard polymeric modular blocks are made of polymethyl methacrylate (PMMA).

3. The method of claim 1, wherein at least one of the intermediate aligners is partially carved through to suit the patient's condition.

4. The method of claim 1, wherein the intermediate aligners have at least one physical substitute tooth portion to suit the patient's condition.

5. The method of claim 1, wherein the intermediate aligners are so carved as to correspond to only some of the patient's upper or lower row of teeth and thus form relatively short aligners to suit the patient's condition.
